(19) United States
(12) Patent Application Publication
(10) Pub. No.: US 2024/0074467 A1
(43) Pub. Date: Mar. 7, 2024

(54) IMMERSION TREATMENT TANK UNLOADING

(71) Applicant: Morris & Associates, Inc., Garner, NC (US)

(72) Inventors: David H. Macaluso, Benson, NC (US); John P. Shell, Raleigh, NC (US); Kimberly L. Ingram, Goldsboro, NC (US)

(21) Appl. No.: 18/462,236

(22) Filed: Sep. 6, 2023

Related U.S. Application Data
(60) Provisional application No. 63/404,254, filed on Sep. 7, 2022.

(51) Int. Cl. A23L 3/3589; A23L 3/00

(52) U.S. Cl. CPC A23L 3/3589; A23L 3/001; A23L 3/003

(57) ABSTRACT

Disclosed are various embodiments for immersion treatment system fluidized unloading. In one embodiment, a product is immersed in a treatment liquid in a chamber of an immersion treatment system. A product mixture is discharged from the chamber to an entry point of a fluidized unloader. The product mixture is transported from the entry point to an exit point via the fluidized unloader. A residence time of the product in the treatment liquid while in the chamber and the fluidized unloader is controlled. The product is separated from the treatment liquid at the exit point of the fluidized unloader.

### CROSS REFERENCE TO RELATED APPLICATIONS

This application claims priority to and the benefit of U.S. Provisional Application No. 63/404,254, filed on Sep. 7, 2022 and entitled “IMMERSION TREATMENT TANK UNLOADING,” which is hereby incorporated herein by reference in its entirety.

### BACKGROUND

In many industrial processes including food preparation, products are treated by immersion in various treatment liquids. For instance, warm products can be chilled by immersion in cold water, cheese curd can be cured by immersion in brine, or food products can be immersed in an antimicrobial solution to reduce microbial contamination. For many years, mechanical unloaders such as so-called “windmill” unloaders or inclined conveyors have been used to remove product from immersion treatment tanks such as poultry chillers or curing tanks. These unloaders can perform acceptably for certain types of products such as whole eviscerated birds. However, for other types of products such as chicken tenders or de-boned thigh meat mechanical unloaders often exhibit operational problems.

Perhaps the greatest concern with mechanical unloaders is damage to certain products when they are scooped out of the treatment tank by the paddles of windmill-type unloaders. The paddles gather product in the treatment liquid and press the product against an outlet wall of the tank. As the product is lifted toward the upper discharge edge of the outlet wall, the product is rubbed across the outlet wall, and the friction can damage fragile products. Furthermore, manufacturing tolerances make it difficult to hold the clearance between the paddle and the outlet wall to anything less than % inch. Gaps that large and even larger are acceptable for whole eviscerated birds for example. However, small or very flexible products such as poultry breast tenders can become wedged in gaps that large resulting in damaged product and inconsistent treatment and operation.

An additional concern with windmill unloaders is that they take up space inside the treatment tank as well as for motors and drive components outside the tank. This space might otherwise be dedicated to treatment of the product or given over to other high-value processing operations.

Inclined belt conveyors have been used to unload small and/or delicate products, but these take up even more space on the processing floor than windmill unloaders making them relatively expensive. Furthermore, such conveyors tend to have a large number of parts, making them more difficult to clean.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows a perspective view of an immersion treatment system using fluidized unloading according to various embodiments of the present disclosure.

FIG. 2 is a section view of a flow control component having sleeve-type valves according to various embodiments of the present disclosure.

FIG. 3 is a detailed view showing a product that is harmlessly pinched by a collapsed sleeve according to various embodiments of the present disclosure.

FIG. 4 shows a schematic drawing of one example of a closed-loop embodiment of the immersion treatment system according to various embodiments of the present disclosure.

FIG. 5 shows a perspective view of an immersion treatment system using gravity-based fluidized unloading according to various embodiments of the present disclosure.

FIG. 6 shows an optimizer algorithm for setting the control output values that should provide the best treatment performance according to various embodiments of the present disclosure.

FIG. 7 represents a system in which a feedback loop based on a performance metric adjusts the unloading rate according to various embodiments of the present disclosure.

FIG. 8 is a drawing of a networked environment according to various embodiments of the present disclosure.

FIG. 9 is a schematic block diagram of the computing environment of FIG. 8 according to an embodiment of the present disclosure.

FIG. 10 is a flowchart that provides one example of a method of treating products using an immersion treatment system according to various embodiments of the present disclosure.

### DETAILED DESCRIPTION

The present disclosure relates to unloaders for immersion treatment tanks. Multiple problems arise in the process of removing certain types of products—especially food products—from an immersion treatment tank using traditional mechanical unloaders. The problems include mechanical damage to fragile products, difficulty maintaining tight mechanical clearances between the unloader and the tank to capture small, flexible and/or slippery product, a large unloading footprint added to base treatment space, difficulties in cleaning the equipment, and potential microbial harborage sites.

Various embodiments of the present disclosure solve these problems by discharging a mixture of product and treatment liquid (product mixture 117) from an immersion treatment tank to a separation device that separates the product from the liquid. A flow regulation device controls the discharge flow rate of the product mixture 117. In some embodiments, gravity provides the motive force for discharging the product mixture 117 through the flow control component. In other embodiments, the flow control component comprises a pump for moving the product mixture 117. Upon separation of the product from the mixture, the product is then directed toward the next processing step while the treatment liquid is either returned to the treatment tank, discarded or directed toward another processing step such as reconstitution. In some examples, treatment in the immersion treatment tank can precede or follow treatment of the products in a chiller.

The flow regulation devices used in some embodiments can be relatively compact compared to mechanical unloaders and can offer flexibility to be located in a variety of positions relative to the discharge end of the treatment tank, thus freeing up space on the production floor. Also, the fluidized unloading systems described in the present disclosure can offer flexibility to discharge the product in a variety of locations, which can eliminate other processing steps in the facility such as conveyors to carry product to the next processing operation.

It is acknowledged that not all products can be suitable for gravity discharge, pumping, and/or separation with a screen. However, many products that are difficult to handle with mechanical unloaders can be successfully handled using embodiments of the present disclosure.

The fluidized unloading system is intended for products for which immersion in a treatment fluid is desired. Products compatible with this fluidized unloading system can include solid particles and/or chunks that are each large enough to separate from the treatment liquid using a screen or similar device yet small enough to pass through conduits and passages in the equipment. Products having characteristic dimensions between about 3 mm (⅛ in) and about 100 mm (4 in) diameter are most applicable, though larger and smaller products can be accommodated. The chunks need not be solid throughout, provided that a surface film surrounding a liquid or paste interior has sufficient integrity to maintain the chunk as a unit. The product can be rigid such as a chicken drumstick, or the product can be extremely pliable such as chicken skin. The product should be able to flow when mixed with treatment fluid. Products used as food, food ingredients, or food by-products can be treated, though other products with similar handling characteristics are suitable. Herein, poultry products are frequently used as examples, but these references are not intended to be limiting.

In many applications, the product is intended to be immersed in a treatment liquid for a specific amount of time. The total residence time includes treatment time spent in the treatment tank and unloading time spent in the fluidized unloader system. (It should be noted that in most applications, “treatment” of the product by exposure to the treatment liquid can continue through the unloading process.) In some embodiments, unloading time can be very small relative to treatment time. In other embodiments, the treatment tank can be no more than an inlet channel for the fluidized unloader system in which case unloading time is a significant portion of the residence time.

The present disclosure lends itself to control unloading time through system design. The unloading time is defined by the volume of the fluidized unloader system between the treatment tank and the separation device divided by the volumetric discharge rate. Thus, there are several design parameters that can be selected to achieve the desired unloading time. These parameters include system volume, volumetric discharge rate and the product-to-liquid ratio in the product mixture 117.

For embodiments utilizing a flow regulation device, the system volume can include the internal volume of conduits connecting the treatment tank to the flow regulation device, the operating volume of the flow regulation device itself, and the internal volume of conduits connecting the flow regulation device to the separation device. The product-to-liquid ratio is the quantity of product 115 divided by the quantity of treatment liquid 113 in a volume of product mixture 117. These quantities are usually expressed as mass of product and liquid, but in some cases it can be convenient to use other measures of quantity such as piece count of product or volume of liquid.

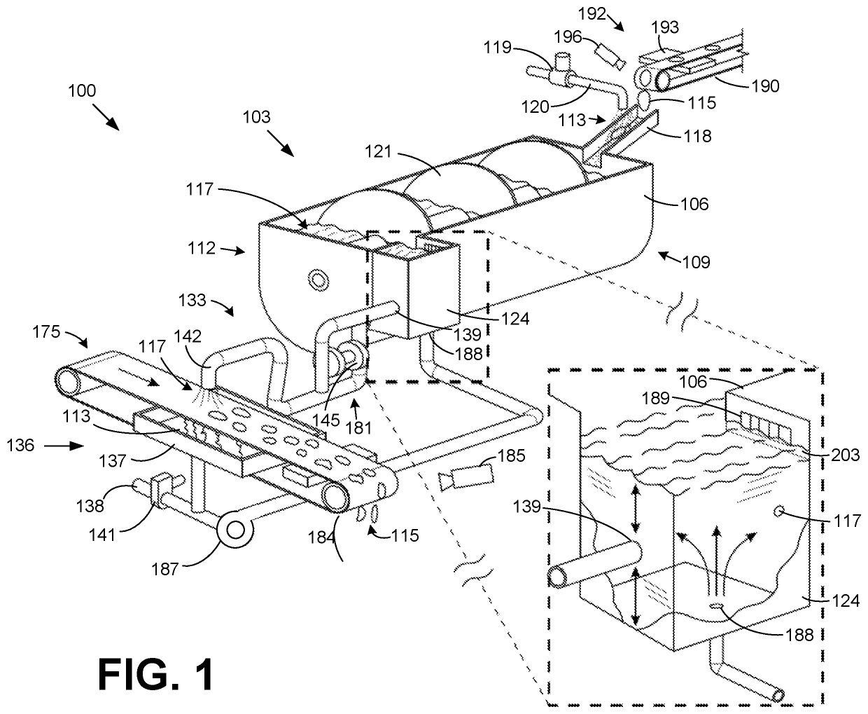

FIG. 1 shows a perspective view and detail view of an immersion treatment system 100 using fluidized unloading according to various embodiments. The immersion treatment system 100 includes a treatment tank 103 having a chamber 106. The chamber 106 has an inlet end 109 and a discharge end 112. The chamber 106 may include means to advance the product from the inlet end 109 to the discharge end 112 such as a screw conveyor 121. Multiple chambers 106 can be used in other embodiments, for example, to accommodate a second conveyor advancing the product in a different direction from a first conveyor.

The treatment tank 103 can also include an outlet box 124 at a discharge end 112 of a chamber 106 in fluid communication with the chamber 106. Treatment tanks 103 come in a variety of configurations. Treatment tanks 103 in a continuous treatment process can be configured to hold treatment liquid 113 and to receive product 115 at the inlet end 109 and unload product 115 at the discharge end 112. The immersion treatment system 100 can include provisions to add treatment liquid 113 to the treatment tank 103 such as a treatment liquid supply line 120, and liquid lines to drain liquid from the treatment tank 103, as well as controls such as automatic valves 119, weirs, and other components to maintain a liquid level 203 in the treatment tank 103. Batch treatment tanks 103 (not illustrated) have a generally open interior containing treatment liquid 113 in which product 115 is deposited for a time and then unloaded. Batch treatment tanks can be fitted with devices to agitate the product 115 in the treatment liquid 113 to maintain a product-to-liquid ratio.

The immersion treatment system 100 can be designed so that the product moves sequentially through it such that the first unit of product introduced into the treatment system is approximately the first piece to be taken out (FIFO). A mechanical device such as a screw conveyor 121 can be used to regulate the advancement of product from the inlet end 109 toward the discharge end 112 of the chamber 106. The motion of the screw conveyor 121 can be controlled in order to control the residence time of the product 115 in the treatment tank 103. In other examples, the bottom surface of the chamber 106 can be sloping from the inlet end 109 to the discharge end 112 to urge the product 115 to move by gravity from the inlet end 109 to the discharge end 112. In still other examples, pressurized air or water can be used to propel or urge the product 115 from the inlet end 109 toward the discharge end 112, and the pressure or aperture size where the air and/or water are introduced to the chamber 106 can be controlled in order to control the residence time of the product 115 in the chamber 106.

Multiple immersion treatment systems may be linked in series, for example to apply successive treatments of different treatment liquids. Embodiments with multiple systems can include sequential operations where the product 115 exiting from an output point 101 of an immersion treatment system 100 is input into an input point 102 of another immersion treatment system 100, which can have the same or a different treatment liquid 113.

The product 115 can be disposed to sink, float, or be neutrally buoyant in the treatment liquid 113 depending on the relative mass densities (or specific gravity) of the product 115 and the treatment liquid 113. This can cause the product-to-liquid ratio to vary naturally at various depths within the treatment liquid. For example, where the specific gravity of the product is significantly different from the specific gravity of the treatment liquid, the product 115 can tend to sink or float creating a gradient of product-to-liquid ratio from the bottom of the outlet box 124 to the liquid level in the box. The system can be designed to accommodate such diverse tendencies while assuring an appropriate product-to-liquid ratio of the product mixture 117 discharged. As further disclosed herein, components of the system can agitate the product mixture 117 to maintain a more consistent product-to-liquid ratio.

The entry point 139 to the fluidized unloader system 133 can be located at an appropriate elevation relative to the liquid level 203 in the outlet box 124 or treatment tank 103. For example, in applications where the product 115 tends to sink in treatment liquid 113, the entry point 139 to the fluidized unloader system 133 would be located near the bottom of the outlet box 124 or treatment tank 103. For applications involving floating product 115, the entry point 139 to the fluidized unloader system 133 can be located just below the liquid level in the outlet box 124 or treatment tank 103. The liquid level in the outlet box 124 and/or the immersion treatment system 100 can be controlled using the weir 189. As a result, the entry point 139 can be adjusted and can be manually or automatically movable and adjustable to be a predetermined distance relative to (e.g., lower than) the weir 189 or the liquid level 203.

The product-to-liquid ratio of the product mixture 117 can be varied to suit operating needs. Some minimum amount of treatment liquid 113 can be required to fluidize the product mixture 117 sufficiently to enable powered flow regulation or gravity discharge. In some applications, a minimum amount of treatment liquid 113 can be needed to complete treatment of the product 115. Very high liquid content increases the size of piping, valves and/or flow control components required to process a given quantity of product 115.

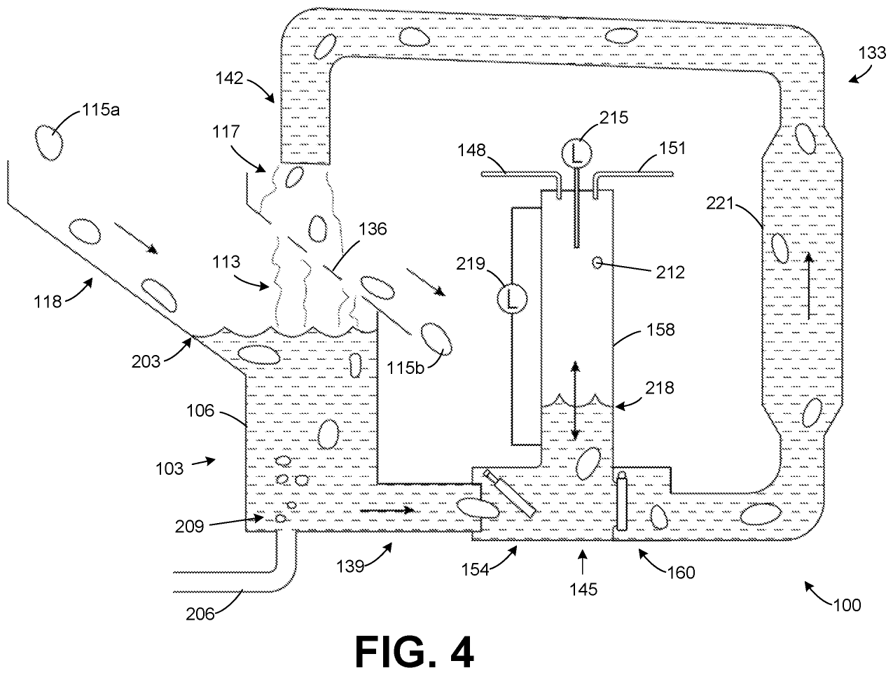

A way to assure consistent product-to-liquid ratio in the product mixture 117 being discharged is to mechanically agitate and suspend the product 115 in the treatment liquid 113. For example, the chamber 106 can have penetrations along the bottom of the chamber 106 through which pressurized air is introduced into the treatment liquid 113. Air rising through the treatment liquid 113 and the product mixture 117 agitates the product 115 suspended therein. In other embodiments, a mechanical agitator 127 (FIG. 4) such as a propeller-type agitator can be suspended in the product mixture 117 to stir it and keep the product 115 in suspension, thereby maintaining a consistent product-to-liquid ratio. In some embodiments, treatment liquid 113 or air can be injected at relatively high velocity through an injection port 188 into the treatment tank 103 to agitate and suspend product 115 in the treatment liquid 113. In embodiments where the product tends to float in the treatment liquid, injection of the treatment liquid 113 can be downward through the surface of product mixture 117 in the treatment tank 103 to encourage consistent distribution of product 115 in the product mixture 117.

A fluidized unloader system 133 is used to move the product mixture 117 from the treatment tank 103 to a separation device 136. The fluidized unloader system 133 can include a flow regulation device 145 to control the flow of product mixture 117 to the separation device 136. The flow regulation device 145 can be located at any convenient point along the length of the fluidized unloader system 133. In some embodiments, the inlet end of the flow regulation device 145 can be coupled to the treatment tank 103 and the outlet end of the flow regulation device 145 can be coupled to the separation device such that the flow regulation device 145 constitutes the entirety of the fluidized unloader system 133. The fluidized unloader system 133 can have an entry point 139 where the product mixture 117 enters the fluidized unloader system 133 from the treatment tank 103 and an exit point 142 where the product mixture 117 discharges onto or into the separation device 136.

The separation device 136 is configured to separate the product 115 from the treatment liquid 113. In some examples, a collection box 137 can be provided to receive the treatment liquid 113 separated from the product mixture 117 by the separation device 136. A pump 187 or other flow control component can circulate some or all of the collected treatment liquid 113 back into the treatment tank 103, possibly after additional filtering or cleaning procedures. Careful design and placement of the nozzle or injection port 188 through which treatment liquid is returned to the treatment tank 103 can achieve all or part of the agitation necessary to maintain uniform product-to-liquid ratio. This causes each unit of volume of product mixture 117 that is processed (e.g., input into and output from the system) to uniformly include a predetermined volume of product. In other embodiments, all or part of the treatment liquid 113 can be discarded from the collection box 137 through a liquid drain 138 and control valve 141.

The separation device 136 can include a moving screen such as a substantially horizontal belt conveyor 175 in which the belt is porous to the treatment liquid 113 but traps the product 115. In some embodiments, a product discharge monitor 182, which can include a belt scale 184 for weighing product and/or an optical system 185 for counting units of product can be used to measure the unloading rate which is the quantity of product leaving the treatment system. In some embodiments the separation device 136 can be a stationary screen such as an inclined bar grate, defining spaces between the bars that are too narrow for product 115 to pass through but allow the treatment liquid 113 to pass as illustrated in FIG. 4. The separation device 136 can be located above the chamber 106 to facilitate return of the treatment liquid 113 separated from the product 115 to the chamber 106 by gravity flow.

The immersion treatment system 100 can include a product infeed monitor 192 to determine the rate of product infeed to the system. For example, where product is delivered to the system by a conveyor 190, the infeed monitor 192 can include a belt scale 193 and/or another type of product infeed monitor 192. In some embodiments, the product may be delivered by a hanging conveyor or shackle line where the product may be weighed as it passes over or through a weigh-in-motion scale. In some embodiments, the infeed monitor 192 can additionally or alternatively include an optical system 196 such as a camera device or another optical device, or an ultrasonic device which can count units of product as they enter the treatment system.

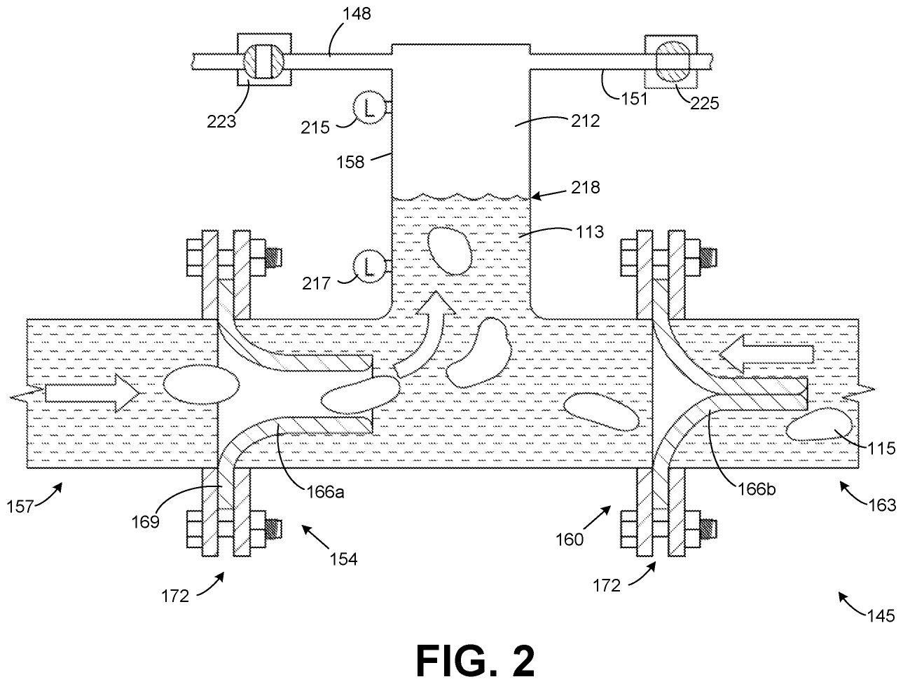

The flow regulation device 145 can facilitate flow of the product mixture 117 through the fluidized unloader system 133. In such embodiments, the style of flow regulation device 145 employed is compatible with moving chunky solids suspended in treatment liquid 113. Generally, positive displacement pumps can be used to more precisely regulate the flow of product mixture 117. Reciprocating pumps such as diaphragm-type pumps, piston-type pumps, or plunger-type pumps are generally applicable. The displacement of the flow regulation device 145 can be large enough to transfer at least several chunks of product 115 in a single stroke. In some applications, progressive cavity pumps can also be suitable. Certain types of centrifugal pump can be compatible with some products, but cannot provide the same level of consistency in discharge flow rate. In other embodiments, the flow control component regulates the flow of product mixture 117 without increasing pressure as a pump does. Various embodiments incorporating an air displacement flow regulation device 145 are described herein with reference to FIG. 2.

The flow regulation device 145 can have a displacement defined as the volume of product mixture 117 moved in a single cycle or revolution of the flow regulation device. In some embodiments, displacement can be adjustable or variable. In other embodiments, displacement can have a fixed value. For commercially sourced pumps such as a progressive cavity pump, the manufacturer typically specifies or discloses the displacement of the device. The flow regulation device speed is the rate at which the device rotates or completes cycles—e.g., cycles/minute.

FIG. 2 is a section view of an air displacement flow regulation device 145 according to various embodiments. The flow regulation device 145 includes a non-return valve 154 (i.e., a check valve) at the inlet 157, a flow control chamber 158 containing a variable volume of the product mixture 117, and a non-return valve 160 at the outlet 163. FIG. 2 illustrates the status of the non-return valves 154, 160 as they are when product mixture 117 is being drawn into the flow regulation device 145. The flow regulation device 145 can be fitted with an air supply connection 148 and an exhaust connection 151 for filling with or removing air 212 respectively.

An air supply valve 223 or inlet connection can include a solenoid valve or a pressure regulating valve or another suitable valve type, that can control the supply of air to the chamber 158. An air exhaust valve 225 or discharge connection of similar type to the air supply valve 223 can control the release of air 212 from the chamber 158 to a vacuum connection. In some applications, the pressure of the product mixture 117 at the inlet 157 can be high enough that a vacuum connection is not needed, and the air 212 in the chamber can be vented to the atmosphere through exhaust valve 225. The flow regulation device 145 can include devices to detect the liquid level in the flow control chamber 158.

The air supply rate can be controlled by varying the amount of time that the air supply valve 223 is opened (on time) and closed (off time). Air supply rate can be specified using a ratio of on time to off time. The air supply rate can be controlled in addition to the overall flow rate of the flow regulation device 145. For example, the flow regulation device 145 can push out the product mixture 117 during an expelling cycle that incorporates multiple openings and closings of the air supply valve 223 according to a specified air supply rate. In other embodiments, the air supply rate can be controlled by regulating the pressure of the air supply.

The exhaust valve 225 can provide an exhaust rate that can be controlled using the on time that the valve is opened, and the off time that the valve is closed. The exhaust rate can be specified using a ratio of on time to off time. The exhaust rate can be controlled in addition to the overall flow rate of the flow regulation device 145. For example, the flow regulation device 145 can draw in the product mixture 117 into the flow control chamber 158 during a draw in cycle that incorporates multiple openings and closings of the exhaust valve 225 according to a specified exhaust rate. In other embodiments, the exhaust rate may be controlled by regulating the pressure of the vacuum connection.

The volume of product mixture 117 in the flow control chamber 158 can be varied by displacing the product mixture 117 with air 212 forced into the flow control chamber 158 from the air supply 148 or exhausted from the flow control chamber 158 through the exhaust connection 151. The amount of variation is constrained by high and low limits to the product mixture level 218 in the chamber. In some embodiments, a high-level sensor 215 such as a level switch and a low-level sensor 217 can be used to determine when the level 218 of product mixture 117 in the flow control chamber 158 reaches the respective high or low limit. In other embodiments, a level measurement sensor 219 (FIG. 4) such as a differential pressure transducer or capacitive level transducer can measure the level 218 of the product mixture 117 in the flow control chamber 158. The volume of the flow control chamber 158 between the high and low limits of level 218 is the flow regulation device displacement which can be adjusted by changing the high and low limits.

In some embodiments, the product mixture 117 can be separated from the air 212 by a free-floating piston, diaphragm or other mechanism.

In some embodiments, the flow regulation device 145 can be double-acting, having two or more flow control chambers 158 that fill and empty in alternating sequence. In other words, multiple flow control chambers 158 and/or flow regulation devices 145 can be used in parallel to reduce surging of the unloading rate. While a first flow control chamber 158 is discharging product mixture 117, a second flow control chamber 158 will draw in product mixture. Then when the first chamber switches to the intake phase of its operating cycle, the second chamber starts discharging. This alternating sequence provides a more nearly continuous unloading rate. Supply valve 223 and Exhaust valve 225 may be three-way valves that divert the flow bath of air from one flow control chamber 158 to another.

The flow control chamber 158 can be sized to contain product mixture 117 that includes at least three to ten chunks of product 115. In other embodiments, the flow control chamber 158 can hold as much product 115 as the system receives in a fixed amount of time. For example, the flow control chamber 158 can hold as much product 115 as the system receives in five to fifteen seconds.

The flow control chamber 158 can be configured to have the air evacuated and replenished in alternate cycles as the flow regulation device 145 draws in and expels the product mixture 117, respectively. The operating cycle starts with the product mixture 117 at a low level in the flow control chamber 158. The exhaust connection 151 or exhaust valve 225 is opened to reduce the pressure in the flow control chamber 158 below the pressure of the product-liquid mixture at the inlet 157. Air 212 evacuates from the flow control chamber 158 drawing product mixture 117 into the flow control chamber 158 through the inlet non-return valve 154.

When the product mixture 117 reaches a high level in the flow control chamber 158, the exhaust connection 151 is closed, and the air supply 148 is opened to allow pressurized air into the flow control chamber 158. The increased pressure closes the inlet non-return valve 154 and pushes the product-liquid mixture out through the outlet non-return valve 160. A pause of variable or predetermined duration can be incorporated between drawing in and expelling the product mixture 117 to allow for regulation of the flow rate.

Increasing the pressure of the air supply 148 can expel product mixture 117 from the chamber faster and enable higher unloading rates. Other embodiments can open the air supply 148 for a fixed duration of time before opening the vacuum connection. Such a procedure eliminates the need for detecting of a low liquid level in the flow control chamber 158. In other embodiments, a piston or plunger in the flow control chamber 158 can be used in place of air 212 to displace product mixture 117 through the operating cycle.

The inlet non-return valve 154 and outlet non-return valve 160 can be of different types in various embodiments such as spring check valves, swing check (flapper) valves (FIG. 4) or even power-operated valves. In some embodiments, such as in the example of FIG. 2, the inlet non-return valve 154 and the outlet non-return valve 160 have the form of a flexible sleeve 166 through which the product mixture 117 passes. The sleeve 166 incorporates or is attached to a relatively rigid or fixed opening at its inlet end, such as a sleeve flange 169 that is retained by a bolted pipe flange 172. However, the sleeve is left free to open or collapse at its discharge end in response to the relative pressure between the inlet and discharge sides of the non-return valves 154, 160 created by the operating cycle. The sleeve 166a is shown as open, while the sleeve 166b is shown as collapsed. Such a configuration avoids damage to fragile products 115 that can be passing through the non-return valves 154, 160 at the moment the pressure reverses. In such an event, the flexible sleeve 166 can simply collapse around the product 115 compressing it slightly, but without pressing it against hard or sharp edges.

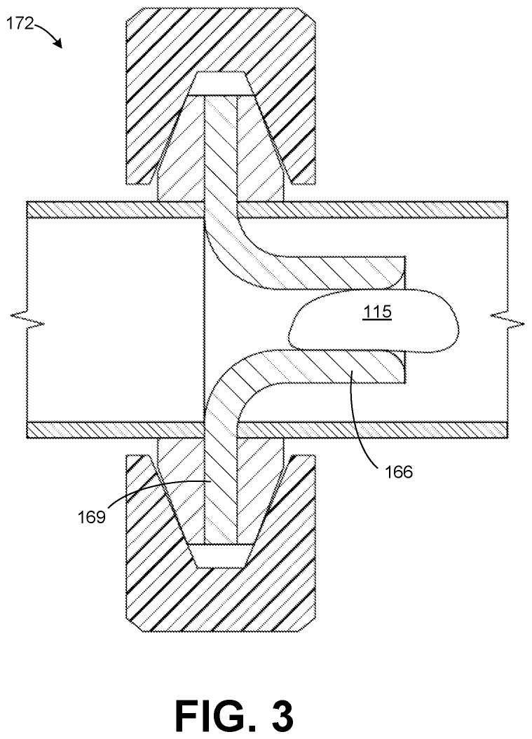

FIG. 3 is a detailed view showing a unit of product 115 that is harmlessly pinched by a collapsed sleeve 166. The sleeve 166 can be designed such that it will not turn inside-out and allow flow back through the inlet of the non-return valves 154, 160 when the pressure on the discharge side of the non-return valves 154, 160 exceeds the inlet pressure. For instance, the length of the sleeve 166 can be 1-2 times the diameter. The sleeve 166 can include a unidirectional sleeve 166 that enables travel of the product 115 and the liquid in a single direction, for example, in response to a pressure differential with higher pressure at an inlet side relative to the discharge side. However, if the inlet side has lower pressure than the discharge side, the sleeve 166 can collapse and prevent backflow, while preventing damage to any product 115 that is trapped by the closing action.

The wall thickness of the sleeve 166 can be thin enough that the sleeve 166 closes completely or nearly completely when pressure at the discharge end rises above pressure at the inlet end. However, the sleeve wall thickness can be selected to be large enough to resist turning inside-out under pressure differential that can exist between the discharge and inlet ends. The sleeve wall thickness can vary along the length of the sleeve 166. The sleeve 166 can be formed with a flange 169 around its inlet end that can be captured between the flanges 172 of a pipe joint, such as a bolted flange or a clamped flange connection. FIG. 3 shows a clamped flange 172 rather than the bolted flanges 172 shown in FIG. 2. The clamped flange can press or clamp down on a wedge shape that holds the flange 169 of the sleeve 166.

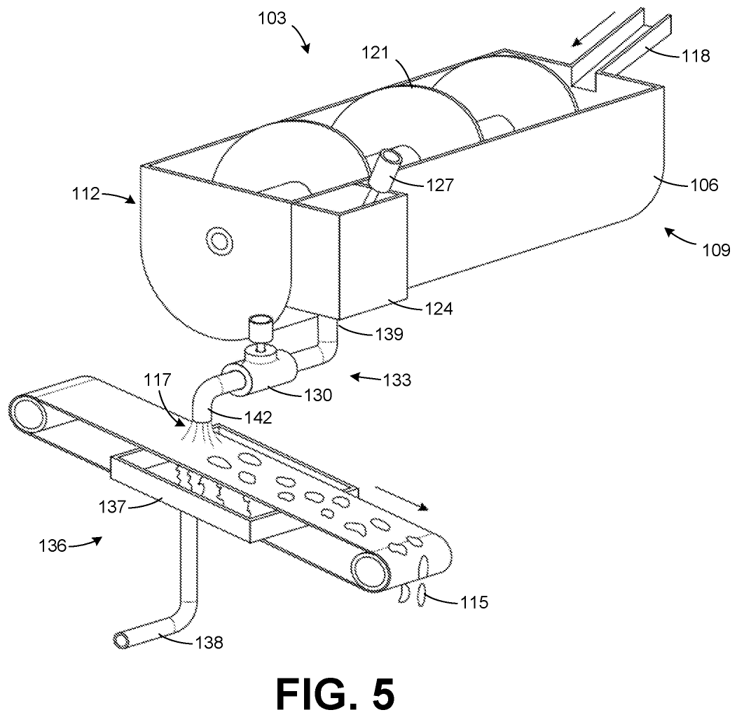

In embodiments of the immersion treatment system 100 wherein flow through in the fluidized unloader system 133 is driven by gravity, a flow regulation device 145 similar to that of FIG. 2 can still be employed, but can be modified to prevent product mixture 117 from draining through the device in an uncontrolled manner. For example, the non-return valves 154 and 160 of FIG. 2 are replaced by power-operated valves such as motor operated ball valves, and the top of the chamber 158 is vented to atmospheric pressure. Further disclosure of such embodiments is provided in relation to FIG. 5.

FIG. 4 shows a schematic drawing of one example of a closed-loop embodiment of the immersion treatment system 100. Such an embodiment would be appropriate for a disinfection application for example. Some embodiments can be used to treat food products 115 with disinfectants to kill dangerous bacteria on the surface of the product 115. In various examples, the treatment liquid 113 can contain one or more antimicrobial agents such as peracetic acid (PAA), cetylpyridinium chloride (CPC), chlorine, ozone, salt or other agents. It can be important to control the residence time of the product 115 in the treatment liquid 113 to ensure that the product 115 has a minimum residence time in the treatment liquid 113 to be sufficiently treated, while making sure that the product 115 does not exceed a maximum residence time whereby the treatment liquid 113 could damage or degrade the product 115.

Raw product 115a is deposited into the treatment tank 103 by way of the inlet chute 118, while treated product 115b is discharged by way of the separation device 136. The treatment tank 103 is configured to hold treatment liquid 113 at a fairly consistent level 203 and is sized to accommodate a number of chunks of product 115 immersed in the treatment liquid 113. For example, the treatment tank 103 can hold fifty to five thousand chunks or particles of product 115. In other embodiments, the treatment tank 103 can hold as much product 115 as the system receives in a fixed amount of time. For example, the treatment tank 103 can hold as much product 115 as the system receives in one minute. In other embodiments, the treatment tank 103 can have a volume that is larger than the displacement of the flow regulation device 145. For example, the treatment tank 103 can have a volume that is three to twenty times the displacement of the flow regulation device. An air supply line 206 can introduce air bubbles 209 into the chamber 106 to facilitate agitation. In other embodiments, mechanical agitators such as propeller agitators can be used.

As previously noted, the volume of the fluidized unloader system 133 influences the unloading time the product 115 spends in the fluidized unloader system 133 and can be designed to achieve a desired value of unloading time. For example, for a discharge conduit or unloader section having a length fixed by the locations of a flow regulation device 145 and separation device 136, the diameter of the unloader section can be increased to increase volume and hence the residence time. In one example, an increased diameter of conduit or volume expansion section 221 is depicted. The volume expansion section 221 can include adapters or connection points that connect the volume expansion section 221 to the rest of the fluidized unloader system 133. In another example, the diameter can be held constant and an additional length of conduit, channel, pipe, or passage can be added to increase residence time in the fluidized unloader system 133. Further, the discharge rate can be controlled as described elsewhere in this disclosure to provide a desired residence time. Such design flexibility is not generally available in traditional mechanical unloaders.

FIG. 5 shows a perspective view of an immersion treatment system 100 using gravity-based fluidized unloading according to various embodiments. As compared with the active flow regulation device 145 of an immersion treatment system 100 of FIG. 1, the flow regulation device 145 has a discharge valve 130 which can regulate the discharge flow through the fluidized unloader system 133 and thereby control the unloading rate and/or residence time. The discharge valve 130 can be considered a passive or gravity-driven flow regulation device 145. Although passive relative to a controlled pump or controlled air pressure device, the discharge valve 130 can include a power-operated valve such as a motor-operated or pneumatically-operated ball valve that alternates between a closed position and an open position according to a periodic rate to control the volume of the product mixture 117 that is discharged. For example, the discharge valve 130 can be opened for a predetermined time (e.g., thirty seconds) and then closed for another predetermined (e.g., forty seconds) that can be the same or different. In another embodiment, the discharge valve 130 is a power-operated valve that partially opens to a position that is determined to control the flow rate of product mixture 117 being discharged. The open position can be determined based at least in part on the size of the product 115 being treated so as to reduce the possibility of the product 115 clogging the aperture in the discharge valve 130.

In other embodiments of gravity-based fluidized unloading systems, the flow regulation device 145 can be similar to that of FIG. 2, but without air supply and vacuum connections to power its operation. Such a device can have power-operated valves in place of the non-return valves 154, 160, and the top of the chamber 158 would be vented to atmosphere. In operation, the inlet power-operated valve 154 would be opened while the outlet power-operated valve 160 remains closed. The product mixture 117 flows through the inlet valve 154 under the influence of gravity to fill the chamber 158. When the level 218 in the chamber 158 reaches a high level, the inlet valve 154 closes and the outlet valve 160 opens to allow the product mixture 117 to flow out of the chamber 158 to the separation device 136. When the level 218 reaches a low level, the valve positions are reversed again. The unloading rate can be slowed by adding variable amounts of time to the cycle during which both valves are closed.

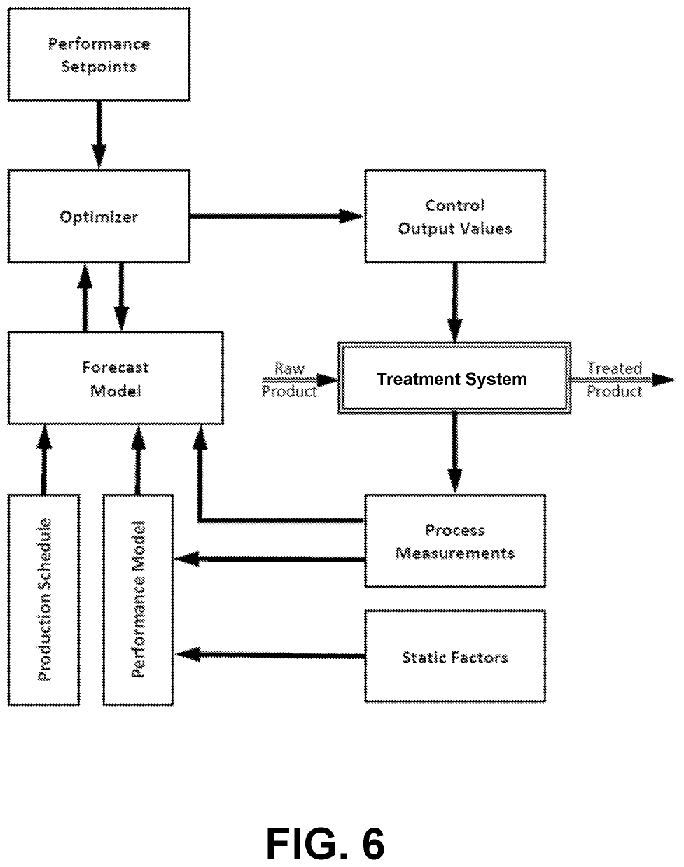

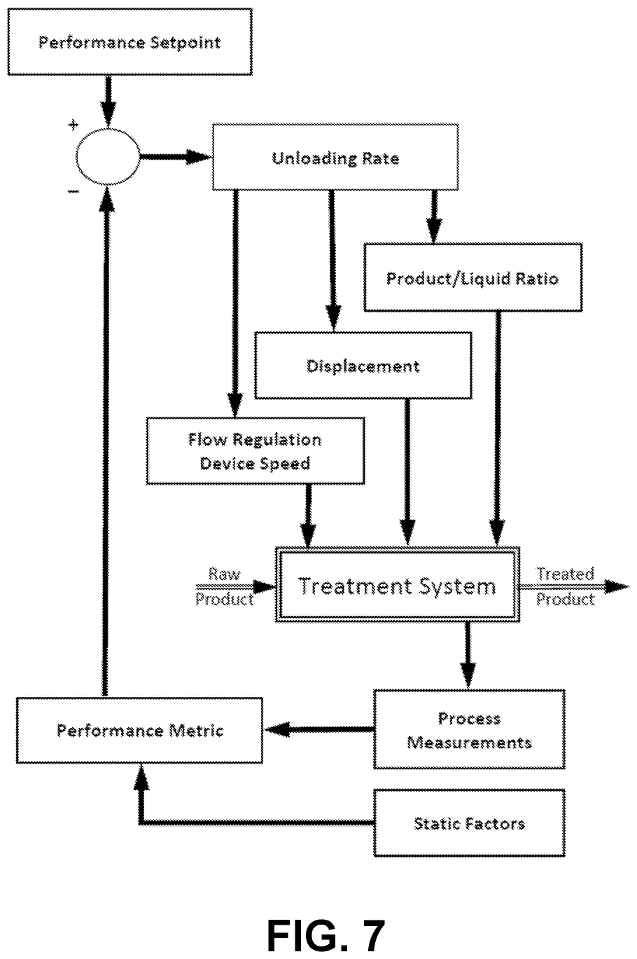

A set of process parameters can be defined that characterize the condition of the immersion treatment system 100 and the product 115 being treated. These parameters can be broadly categorized as performance metrics, control outputs, process measurements, static factors and derivatives. These categories and individual parameters are further explained herein. The relationships among these parameters and their potential use in controlling the immersion treatment system 100 are illustrated in FIGS. 6 and 7. Some process parameters of interest can include tank volume as a function of liquid level, conduit volume, product inventory, measured or expected treatment efficacy, product infeed rate as a function of time, treatment liquid supply, and discharge rates as a function of time.

A set of performance metrics defines and quantifies the processor's objectives in treating the product 115. Examples of performance metrics might include unloading rate, residence time or various measures of treatment efficacy such as product temperature, product yield or residual contamination. For example, the processor might have an objective of delivering a certain quantity of product 115 each minute to the next processing step downstream of the immersion treatment system 100 with scheduled breaks in delivery in order to maintain the overall production schedule for the facility. The applicable performance metric would be an unloading rate. These and other possible metrics are further described herein. The processor arbitrarily sets performance setpoints (i.e., desired values for performance metrics) which setpoints can change over the course of operations as represented in FIG. 6.

The immersion treatment system 100 includes one or more physical control elements such as flow regulation devices, valves, etc. that can be adjusted to alter operation of the immersion treatment system 100. A controller generates control output values that are communicated to control elements to regulate the operation of the respective element. Some control outputs have analog values (e.g., motor speed, valve aperture size) while others can be discrete (e.g., on/off, open/closed). Control outputs can generally be assigned arbitrary values within a range of allowed values. Some or all control outputs can be under optimized control meaning that the control algorithm dynamically adjusts the value of such parameters as treatment conditions evolve. The remaining control outputs can be under manual control or static control meaning that the control algorithm sets the control output to a particular value at the start of operations but does not continuously adjust the value as treatment conditions evolve.

The objective of automated control is to set the optimized control outputs to values that cause performance metrics to conform most closely to the established performance setpoints. FIG. 6 shows an optimizer algorithm setting the control output values that can provide the best treatment performance. The optimizer works iteratively with a forecast model of the immersion treatment system 100 to select control output values. Herein, the optimizer and forecast model are collectively referred to as a controller. Typically, the control output values can be applied for a fixed amount of time referred to as a time step before being updated for subsequent time steps.

The forecast model is an algorithm that uses parameter values from the current condition of the treatment tank along with trial control outputs from the optimizer to estimate the future condition of the immersion treatment system 100 and product 115 for the next one or more time steps. The estimate includes forecast values for performance metrics.

At each time step, the optimizer generates multiple sets of trial values for the control outputs and sends them to the forecast model which returns forecast values of the performance metrics. The set of control outputs that generate performance metric values that best match the performance setpoints is selected for use in the next time step.

Some of the parameters used to represent the current condition can be measured directly and are represented in FIG. 6 by the box labeled “process measurements.” Other parameters—referred to as derivatives—can be difficult to measure directly but can be calculated or estimated from process measurements. The algorithms for generating derivatives are represented in FIG. 6 by the box labeled “performance model.”

The box labeled “static factors” in FIG. 6 represents parameters that do not change or change infrequently but are nonetheless useful for calculating derivatives and performance metrics. For example, the liquid holding capacity of the chamber 106 expressed as a function of liquid level 203 is useful in calculating certain derivatives and performance metrics. Such static factors can be entered by the operator as the need arises.

The box labeled “production schedule” in FIG. 6 represents the possibility that the production schedule for the processing facility can be used to improve the accuracy of the forecast model. For example, the production schedule can call for the product 115 to be loaded into the immersion treatment system 100 at a particular rate over a particular time period after which no product is loaded for the next time interval. Factoring such information into the forecast would reduce forecast error around the time of such transitions. Schedule information can be entered manually by an operator or transferred from an information network in the facility.

In some applications, acceptable treatment performance can be achieved without a forecast model. In such situations, the optimizer and forecast model algorithm can be replaced by feedback functions to set unloader control outputs. In some embodiments, the feedback functions can be proportional—integral—derivative (PID) control loops or other types of control feedback loops.

FIG. 7 represents a system in which control outputs are controlled by a feedback loop based on a performance metric. In an embodiment represented by FIG. 7, a feedback output parameter, unloading rate, is used to generate multiple dependent outputs, namely product-to-liquid ratio, flow regulation device displacement and flow regulation device speed. Each dependent output block in the figure represents a calculation of the named output value as a function of the unloading rate. As noted earlier, there can be additional control elements that are controlled statically. Note that performance setpoints are specific values of their respective metrics and can vary over time.

In applications where more than one performance metric can be optimized independently, additional feedback loops can be employed as desired to generate independent output values.

The circle element of FIG. 7 represents a control algorithm. This algorithm can be any variant of a PID control loop or a predictive control algorithm or any other type of single-output control algorithm.

The preferred mathematic formula to be used for each of the functions described herein is dependent on the details of each application. Consequently, the method described allows a practitioner to determine by experimentation as well as by deterministic principles the preferred form of functions to be used in controlling the treatment process. Indeed, the control algorithm can benefit from periodic or continual feedback to calibrate these formulae.

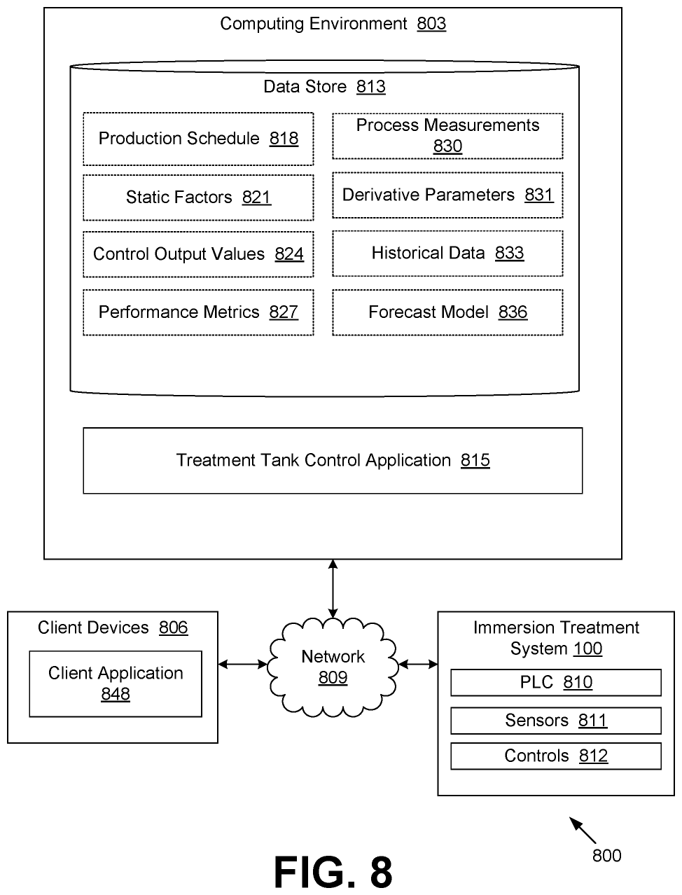

With reference to FIG. 8, shown is a networked environment 800 according to various embodiments. The networked environment 800 includes a computing environment 803, one or more client devices 806, and one or more immersion treatment systems 100, which can be in data communication with each other via a network 809. The network 809 includes, for example, the Internet, intranets, extranets, wide area networks (WANs), local area networks (LANs), wired networks, wireless networks, cable networks, satellite networks, or other suitable networks, etc., or any combination of two or more such networks. The immersion treatment systems 100 are instrumented as described with a programmable logic controller (PLC) 810 that is connected to a plurality of sensors 811 and a plurality of controls 812. In other examples, the immersion treatment systems 100 can include a computing device such as a server computer, embedded computing system, and so on, directly connected to the sensors 811 and the controls 812.

The computing environment 803 can comprise, for example, a server computer, a PLC, an embedded computing device, or any other system providing computing capability. Alternatively, the computing environment 803 can employ a plurality of computing devices that can be arranged, for example, in one or more server banks or computer banks or other arrangements. Such computing devices can be located in a single installation or can be distributed among many different geographical locations. For example, the computing environment 803 can include a plurality of computing devices that together can comprise a hosted computing resource, a grid computing resource, and/or any other distributed computing arrangement. In some cases, the computing environment 803 can correspond to an elastic computing resource where the allotted capacity of processing, network, storage, or other computing-related resources can vary over time.

Various applications and/or other functionality can be executed in the computing environment 803 according to various embodiments. Also, various data are stored in a data store 813 that is accessible to the computing environment 803. The data store 813 can be representative of a plurality of data stores 813 as can be appreciated. The data stored in the data store 813, for example, is associated with the operation of the various applications and/or functional entities described below.

The components executed on the computing environment 803, for example, include a treatment tank control application 815 and other applications, services, processes, systems, engines, or functionality not discussed in detail herein. The treatment tank control application 815 is executed to manage and optimize the operation of the immersion treatment system 100 that has been instrumented with the sensors 811 and the controls 812. For example, the treatment tank control application 815 can implement a Supervisory Control and Data Acquisition (SCADA) system in conjunction with the PLC 810, where the client devices 806 do not have direct access to sensors 811 and controls 812.

The data stored in the data store 813 include, for example, a production schedule 818, one or more static factors 821, one or more control output values 824, one or more performance metrics 827, one or more process measurements 830, one or more derivative parameters 831, historical data 833, one or more forecast models 836, and potentially other data.

The production schedule 818 includes data describing a schedule for delivery of raw product 115 to the immersion treatment system 100 and delivery of treated product 115 to further processing operations downstream of the treatment tank 103 including scheduled interruptions (breaks) and changes in rate of delivery. The production schedule 818 can also include scheduled changes in product properties, which can affect the type of treatment to be provided in the immersion treatment system 100. For example, larger product 115 can require longer treatment times, while smaller product 115 can require shorter treatment times. The production schedule 818 can also document the availability of manual operators to intervene and make manual adjustments.

The static factors 821 correspond to factors important to precise control of the immersion treatment system 100 but which do not change appreciably during the course of daily operation. However, these factors can vary widely from one application to another, and such variation can alter the form of mathematical expressions used to characterize some of the dynamic factors and functions disclosed herein. The physical size and shape of the immersion treatment system 100 can influence the way product responds to treatment processes and informs the preferred control algorithms. The immersion treatment system 100 can be characterized by internal length, width or diameter, maximum depth or other characteristics of the chamber 106, characteristics of the fluidized unloader system 133, and characteristics of a flow regulation device 145 and/or flow regulation system.

The static factors 821 can also include product characteristics, such as unit weight, specific gravity of the product, thermal conductivity and/or thermal diffusivity of the product, and so on. The unit weight corresponds to the average mass of individual units or pieces of product. The specific gravity of the product determines whether product sinks, floats or is neutrally buoyant in the treatment liquid 113. The thermal conductivity of the product affects how long it takes to add or remove heat from the interior of product units.

The control output values 824 correspond to values set for the operation of the controls 812 of the immersion treatment system 100. Non-limiting examples of control output values 824 can include flow regulation device displacement and speed, recirculation device 187 speed, treatment liquid supply rate, agitation fluid flow rate, discharge valve setting, screw conveyor speed, drain flow, liquid temperature, and so forth. Control output values 824 can include displacement of the unloading flow regulation device or drain system, the speed or cycle rate of the unloading system, and the product-to-liquid ratio at the inlet to the fluidized unloader system 133. At a more granular level, control of the air supply and discharge valves on the unloading flow regulation device can be used as control outputs.

Components for flow control and regulation can include a liquid supply valve 119 in the treatment liquid supply line 120, control and power to a liquid supply flow regulation device 145 or other components. A liquid supply control valve 119 can be a solenoid valve, a motorized valve or other type of controllable valve. Components for monitoring flow can comprise a flow switch installed in the treatment liquid supply line 120, a flow meter such as a paddle wheel flow meter, a pressure sensor downstream of the flow control valve or other components. Flow can be inferred in some implementations by simply monitoring the status of the flow control valve.

The agitation fluid flow (Fa) can also be controlled. In some treatment tanks, a fluid such as air bubbles 209 or treatment liquid is injected below the liquid level as illustrated in FIG. 4 to agitate or stir the treatment liquid and enhance contact with the product. Agitation flow can have an analog value expressed in units of volume/time such as cubic feet per minute. In some embodiments, agitation flow can be controlled as a continuous variable. In other embodiments, the algorithm can treat agitation flow as a binary value (i.e., on or off). Means for monitoring and controlling agitation fluid flow are similar to those for makeup liquid flow. Where the fluid is air, control can be applied to a blower rather than a pump.

Various performance metrics 827 can be monitored by way of the sensors 811 and optimized by way of the controls 812. For example, performance metrics 827 can include a treated product delivery schedule or unloading rate, a flow regulation device 145 speed or setting, a flow control displacement metric, a product-to-liquid ratio, a treated product yield, a treated product internal temperature, and/or other metrics. Performance metrics 827 can also include a residence time for units of product in the immersion treatment system 100 or part of the treatment system such as the fluidized unloader system 133. Further performance metrics 827 can include measures of treatment efficacy such as product temperature, yield, composition, pH, and other metrics that are influenced by residence time. For simplified control systems, internal temperature and yield can be assumed to be met if the delivery schedule and the product-to-liquid ratio are maintained. The performance metrics 827 can include any of the process parameters discussed, including quantity of product mixture in the treatment tank as a function of liquid level, conduit volume, product inventory, treatment efficacy, product infeed rate as a function of time, treatment liquid supply, discharge rates as a function of time, and others.

The process measurements 830 can include readings from the sensors 811. For example, the process measurements 830 can include a product infeed rate, a treatment liquid supply rate, a supply liquid temperature, a treatment liquid temperature in the treatment tank, a tank liquid level 203, a flow regulation device 145 chamber liquid level 218, a treatment liquid recirculation flow rate, a product unloading rate, an agitation fluid flow rate, and so on. Generally, the process measurements 830 can refer to sensor-based or otherwise measured values of any of the performance metrics 827, as well as values from which the performance metrics 827 can be calculated.

The product infeed rate (min) can be expressed as mass/time. The control algorithm can use other quantities as a substitute for mass/time. For example, where most units (pieces) of product have a consistent mass, the rate at which units of product are added to the tank expressed as number of pieces/time can be used in place of mass/time. The volume of product discharge can be determined by a optical scanner measuring the profile of product passing by on a conveyor. Infeed rate can be measured by weighing the product directly as with a product infeed monitor 192, for example, a belt scale 193 or an optical device 196. Piece rate of delivery can be measured using a proximity sensor to count product units as they pass a location on the shackle line feeding the treatment tank. Such a proximity sensor might comprise an optical device that changes state when a solid object breaks a light beam in front of the sensor. In other embodiments, alternative devices for weighing or counting product in motion toward the immersion treatment system 100 can be used.

Product weight can be measured via load cells when the product is deposited in or removed from the immersion treatment system 100. The product discharge monitor 184 and the product infeed monitor 192 can include load cells such as a belt scale, a hanger scale for hanging products, and other load measurement devices that can measure weight or mass. Product surface temperature can be measured via infrared sensors when the product is deposited in or removed from the immersion treatment system 100. For example, a thermal sensor can scan product entering the immersion treatment system 100 at the input point 102, and another thermal sensor can scan product leaving immersion treatment system 100 at the output point 101.

The derivative parameters 831 can include parameters that are calculated based upon process measurements 830, control output values 824, static factors 821, the production schedule 818, and/or other data. Non-limiting examples of derivative parameters 831 can include product inventory in the treatment system, unloading rate, treatment time and product-to-liquid ratio.

The historical data 833 can include historical values for production schedules 818, static factors 821, control output values 824, performance metrics 827, process measurements 830, and derivative parameters 831 for the same immersion treatment system 100 or other immersion treatment systems 100. The historical data 833 can be used as training data for a machine learning algorithm used to generate the forecast model 836 and/or to optimize the performance metrics 827. Machine learning algorithms can involve linear regression, logistic regression, K-means clustering, gradient descent, and others.

The client device 806 is representative of a plurality of client devices 806 that can be coupled to the network 809. The client device 806 can comprise, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client device 806 can include a display comprising, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 806 can be configured to execute various applications such as a client application 848 and/or other applications. The client application 848 can be executed in a client device 806, for example, to access network content served up by the computing environment 803 and/or other servers, thereby rendering a user interface on the display. To this end, the client application 848 can comprise, for example, a browser, a dedicated application, etc., and the user interface can comprise a network page, an application screen, etc. The client device 806 can be configured to execute applications beyond the client application 848 such as, for example, email applications, social networking applications, word processors, spreadsheets, and/or other applications.

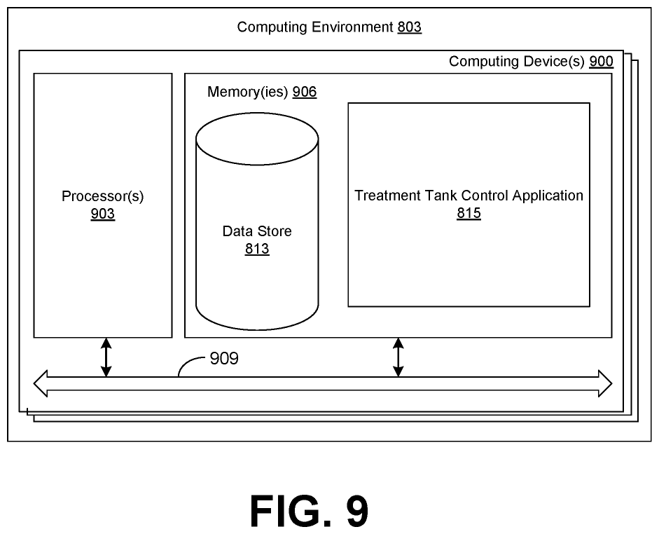

With reference to FIG. 9, shown is a schematic block diagram of the computing environment 803 according to an embodiment of the present disclosure. The computing environment 803 includes one or more computing devices 900. Each computing device 900 includes at least one processor circuit, for example, having a processor 903 and a memory 906, both of which are coupled to a local interface 909. To this end, each computing device 900 can comprise, for example, at least one server computer or like device. The local interface 909 can comprise, for example, a data bus with an accompanying address/control bus or other bus structure as can be appreciated.

Stored in the memory 906 are both data and several components that are executable by the processor 903. In particular, stored in the memory 906 and executable by the processor 903 are the treatment tank control application 815 and potentially other applications. Also stored in the memory 906 can be a data store 813 and other data. In addition, an operating system can be stored in the memory 906 and executable by the processor 903.

It is understood that there can be other applications that are stored in the memory 906 and are executable by the processor 903 as can be appreciated. Where any component discussed herein is implemented in the form of software, any one of a number of programming languages can be employed such as, for example, C, C++, C #, Objective C, Java®, JavaScript®, Perl, PHP, Visual Basic®, Python®, Ruby, Flash®, or other programming languages.

A number of software components are stored in the memory 906 and are executable by the processor 903. In this respect, the term “executable” means a program file that is in a form that can ultimately be run by the processor 903. Examples of executable programs can be, for example, a compiled program that can be translated into machine code in a format that can be loaded into a random access portion of the memory 906 and run by the processor 903, source code that can be expressed in proper format such as object code that is capable of being loaded into a random access portion of the memory 906 and executed by the processor 903, or source code that can be interpreted by another executable program to generate instructions in a random access portion of the memory 906 to be executed by the processor 903, etc. An executable program can be stored in any portion or component of the memory 906 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 906 is defined herein as including both volatile and nonvolatile memory and data storage components. Volatile components are those that do not retain data values upon loss of power. Nonvolatile components are those that retain data upon a loss of power. Thus, the memory 906 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, the processor 903 can represent multiple processors 903 and/or multiple processor cores and the memory 906 can represent multiple memories 906 that operate in parallel processing circuits, respectively. In such a case, the local interface 909 can be an appropriate network that facilitates communication between any two of the multiple processors 903, between any processor 903 and any of the memories 906, or between any two of the memories 906, etc. The local interface 909 can comprise additional systems designed to coordinate this communication, including, for example, performing load balancing. The processor 903 can be of electrical or of some other available construction.

Although the treatment tank control application 815 and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the treatment tank control application 815, that comprises software or code can be embodied in any non-transitory computer-readable medium for use by or in connection with an instruction execution system such as, for example, a processor 903 in a computer system or other system. In this sense, the logic can comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including, for example, static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein, including the treatment tank control application 815, can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device 900, or in multiple computing devices 900 in the same computing environment 803.

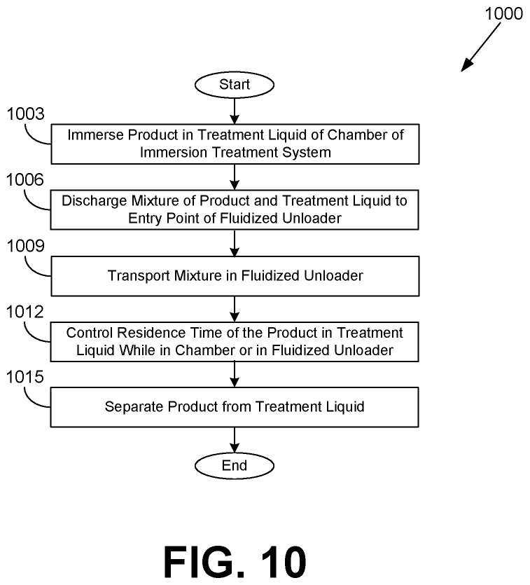

Referring next to FIG. 10, shown is a flowchart 1000 that provides one example of a method of treating products 115 using an immersion treatment system 100 according to various embodiments. Beginning with box 1003, product 115 is immersed into a treatment liquid 113 in a chamber 106 of an immersion treatment system 100. For example, the product 115 can be deposited into the chamber 106 by way of the inlet chute 118. The product 115 moves from the inlet end 109 to the discharge end 112 of the chamber 106 by operation of gravity (e.g., a sloped bottom), a screw conveyor 121, forced air or fluid, and/or other approaches.

In box 1006, a mixture of the product 115 and the treatment liquid 113 is discharged from the chamber 106 to the entry point 139 of a fluidized unloader system 133. In this regard, an aperture in the chamber 106 can provide access to the fluidized unloader system 133. In some cases, the size of the aperture can be controlled by way of a discharge valve 130.

In box 1009, the mixture is transported in the fluidized unloader system 133, either by the operation of a flow regulation device 145 in the fluidized unloader system 133 (e.g., FIG. 1) or by operation of gravity in a gravity-type discharge (e.g., FIG. 5). In box 1012, the treatment tank control application 815 controls the residence time of the product 115 in the treatment liquid 113 while the product 115 is in the treatment tank 103 and in the fluidized unloader system 133. To this end, the treatment tank control application 815 can control the unloading rate by way of the flow regulation device 145 operating parameters and/or valves that allow gravity discharge. Monitoring can be performed with respect to liquid levels, agitation parameters, product outfeed rate, and/or other parameters.

In box 1015, the product mixture 117 is discharged onto a separation device 136, and the product 115 is separated from the treatment liquid 113. The treatment liquid 113 that is recovered can be discarded or reused in the chamber 106. In some embodiments, the recovered treatment liquid 113 can be reconstituted before reuse. Thereafter, the flowchart 1000 ends.

The methods and equipment of this invention can be used to control product unloading rate from an immersion treatment system. The product unloading rate (Pₒᵤₜ) is a function of at least three independent parameters: product-to-liquid ratio (M_{P}/M_{L}), flow regulation device 145 displacement (V_{D}) and flow regulation device 145 speed (S). The unloading rate is managed or controlled by manipulating control points (outputs) associated with these parameters using the methods described in relation to FIGS. 6 and 7. The parameters are related by the following equation where ρₘᵢₓ is the bulk density of the product mixture 117:

Pₒᵤₜ=(M_{P}/M_{L})/(M_{P}/M_{L}+1)×ρₘᵢₓ×V_{D}×S

Product-to-liquid ratio can vary as the product progresses through the immersion treatment system 100. For the purposes of controlling unloading rate, product-to-liquid ratio is typically specified at the entry point 139 to the fluidized unloader system 133 or in the flow regulation device 145. Product-to-liquid ratio can be manipulated as follows:

Product-to-liquid ratio can be diluted by adding treatment liquid 113 to the product mixture 117. In some embodiments, treatment liquid is added from a treatment liquid supply line 120. In other embodiments, a recirculation device 187 such as a pump, a gravity feed system, or another device can return all or part of the liquid effluent from the separation device 136 to the treatment tank 103 to reduce the product-to-liquid ratio. For instance, recirculated liquid can be added to an outlet box 124 to reduce the product-to-liquid ratio of product mixture 117 entering a fluidized unloader system 133.

Product-to-liquid ratio can be concentrated by removing treatment liquid 113 from the product mixture 117. In some embodiments wherein product tends to sink in the treatment liquid, product-to-liquid ratio can be increased by removing treatment liquid over a weir 189 or another level control device located at a liquid level 203 in the upper portion of the treatment tank 103. In some embodiments, a screen across the top of the weir 189 prevents product from passing over the weir 189, but allows treatment liquid to pass. In other embodiments where product tends to float in the treatment liquid, treatment liquid can be drained from a port well below the liquid level 203 in the treatment tank 103.

Various controllable devices such as pumps, valves, and adjustable weirs 189 can be employed to manage the addition or removal of treatment liquid for the purpose of controlling the product-to-liquid ratio.

In some embodiments, displacement of the flow regulation device 145 can be adjusted during operation thus providing a control point for managing the unloading rate. For example, in the embodiment of a flow regulation device 145 represented in FIG. 4, the high limit and low limit of the product mixture 117 level 218 in the flow control chamber 158 can be changed during operation simply by changing setpoints for those values in the control algorithm. Input from a level sensor 219 is compared against the high and low limits. Reducing the distance between the high and low limits can reduce the displacement of the device. In other embodiments, displacement can have a fixed value in which case other methods disclosed herein can be used to manage the unloading rate.

Setting flow regulation device speed provides another control point for unloading rate. The speed of motor-driven flow control devices 145 can be adjusted by changing the motor speed as with a variable frequency drive. The speed of pneumatically-driven flow control devices 145 can be adjusted by changing the pressure of air driving the device. In other embodiments, speed can be adjusted by changing the timing of events in the cycle of operation.

In the flow regulation device 145 of FIG. 2, a pause of a predetermined time period can be added between the time the air supply 148 is closed and the time the exhaust connection 151 is opened to change the flow regulation device speed. In some embodiments, the pressure of the air supply 148 and/or the exhaust connection 151 can be controlled to adjust the speed with which product mixture 117 is expelled from or drawn into the chamber 158 during each cycle of the flow regulation device 145.

At least three control strategies are available for specifying unloading rate: 1) The unloading rate can be controlled to a schedule established by the operator. 2) The unloading rate can be managed to provide the desired residence time in the treatment system, which residence time can vary over the course of operation. 3) The unloading rate can be managed to provide the desired level of treatment efficacy.

In some embodiments, the unloading rate (Pₒᵤₜ) can be controlled to match a production schedule 818 established by the operator. In such embodiments, the operator can establish a schedule for unloading rate that can include different rates at different times including rates of zero for periods of time corresponding to breaks in production. Here, the performance metric is unloading rate, and the setpoint is the target set in the schedule. As described in other sections of this disclosure, a control system can be employed to match the unloading rate of the treatment system to the scheduled rate by managing one or more outputs associated with the product-to-liquid ratio, flow regulation device displacement and flow regulation device speed.

In other embodiments, the unloading rate can be managed to provide the desired residence time (T_{R}) in the treatment system, which residence time can vary over the course of operation. The immersion treatment system 100 can be designed so that the product moves sequentially through it such that the first unit of product introduced into the treatment system is approximately the first piece to be taken out (FIFO). Consequently, the residence time (Δt_{R}(t) which can be variable over time) is defined as the time difference between a unit of product loading into the treatment system (at time=tᵢₙ) and the same unit of product unloading (at tₒᵤₜ).

Δt_{R}(tₒᵤₜ)=tₒᵤₜ−tᵢₙ

The unloading rate (Pₒᵤₜ(t) which can be variable over time) can be controlled by the means described previously to drive the residence time to the desired value. The unloading rate is constrained by two equations. The first describes unloading rate as a function of product infeed rate (Pᵢₙ(t)) and the rate of change in residence time (d/dt Δt_{R}(tₒᵤₜ)).

Pₒᵤₜ(tₒᵤₜ)=f(Pᵢₙ(tᵢₙ),d/dtΔt_{R}(tₒᵤₜ))

The second equation expresses the requirement that before a unit of product entering the treatment system can be unloaded, all the product residing in the treatment system M_{inventory}(t) which may be variable over time) at that time (tᵢₙ) can be unloaded first.

∫ₜᵢₙ^{t}ₒᵤₜPₒᵤₜdt=M_{inventory}(tᵢₙ)=∫₀^{t}ᵢₙ(Pᵢₙ−Pₒᵤₜ)dt

Solution of these equations requires knowledge of the time history of the independent variables. In practice, the control system can record the history and generate a value for unloading rate that satisfies both conditions. As described in other sections of this disclosure, the control system can then match the unloading rate of the treatment system to the desired rate by managing one or more of the product-to-liquid ratio, flow regulation device displacement and flow regulation device speed.

In yet other embodiments, the unloading rate can be managed to provide the desired level of treatment efficacy. In such embodiments, a metric is established to measure treatment efficacy. Depending on the treatment desired, the metric can be product temperature, yield, composition, pH, durometer (firmness), etc. The chosen metrics are used in control algorithms as suggested in FIG. 6 or 7 to manage outputs related to the product-to-liquid ratio, flow regulation device displacement and/or flow regulation device speed in order to control unloading rate.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, the following is claimed:

1. An immersion treatment system for treating a product by immersion in a treatment liquid, the immersion treatment system comprising:
a treatment tank for holding the treatment liquid for treating the product;
a fluidized unloader system configured to transport a product mixture of the product and the treatment liquid from an entry point at a discharge end of the treatment tank to an exit point, the fluidized unloader system comprising a flow regulation device to control flow of the product mixture; and
a separation device configured to receive a discharge of the product mixture from the exit point of the fluidized unloader system and to separate the product from the treatment liquid.

2. The immersion treatment system of claim 1, wherein the product is a food product, and the treatment liquid comprises an antimicrobial agent selected from a group consisting of peracetic acid (PAA), cetylpyridinium chloride (CPC), chlorine, ozone or salt.

3. The immersion treatment system of claim 1, wherein the fluidized unloader system transports the product mixture to the separation device by gravity.

4. The immersion treatment system of claim 1, wherein the flow regulation device comprises an inlet, an outlet, a first non-return valve at the inlet, a flow control chamber containing a variable volume of the product mixture, and a second non-return valve at the outlet.

5. The immersion treatment system of claim 4, the first non-return valve and the second non-return valve individually comprise a sleeve having a fixed inlet opening and a flexible outlet opening that opens or collapses according to relative pressure generated by the flow regulation device.

6. The immersion treatment system of claim 1, wherein the flow regulation device corresponds to an air displacement flow regulation device, and the air displacement flow regulation device comprises an air supply connection to supply air to a flow control chamber and an exhaust connection for removing air from the flow control chamber.

7. The immersion treatment system of claim 1, wherein the flow regulation device has two or more flow control chambers that fill and empty in alternating sequence.

8. The immersion treatment system of claim 1, wherein the flow regulation device comprises a valve configured to regulate flow of the product mixture.

9. The immersion treatment system of claim 8, further comprises a controller configured to alternate the valve between an open position and a closed position at a periodic rate based at least in part on a controlled product mixture flow rate, wherein the open position is determined based at least in part on a size of the product.

10. The immersion treatment system of claim 1, wherein the treatment tank includes a screw conveyor configured to regulate advancement of the product through the treatment liquid in the treatment tank from an inlet end of the treatment tank to the discharge end of the treatment tank.

11. The immersion treatment system of claim 1, wherein the treatment tank includes a sloping interior bottom surface configured to move the product by gravity through the treatment liquid in the treatment tank from an inlet end of the treatment tank to an unloading end of the treatment tank.

12. The immersion treatment system of claim 1, wherein the treatment tank further comprises an agitator configured to maintain a consistent product-to-liquid ratio in the treatment liquid.

13. A method for treating a product, comprising:
immersing the product in a treatment liquid in a treatment tank of an immersion treatment system;
discharging a product mixture from the treatment tank to an entry point of a fluidized unloader system;
transporting the product mixture from the entry point to an exit point via the fluidized unloader system;
controlling a residence time of the product in the treatment liquid while in the treatment tank and the fluidized unloader system using a flow regulation device of the fluidized unloader system; and
separating the product from the treatment liquid at the exit point.

14. The method of claim 13, wherein the immersion treatment system further comprises a valve that regulates flow of the product mixture through the fluidized unloader system, and the method further comprises alternating the valve between an open position and a closed position at a periodic rate based at least in part on the residence time.

15. The method of claim 14, further comprising determining the open position based at least in part on a size of the product.

16. The method of claim 14, further comprising moving the product mixture from the treatment tank and through the fluidized unloader system using a positive displacement pump.

17. The method of claim 16, further comprising operating the positive displacement pump based at least in part on the residence time.

18. The method of claim 13, further comprising agitating the product in the treatment liquid within at least a portion of the treatment tank to maintain a consistent product-to-liquid ratio.

19. An immersion treatment system for treating a food product by immersion in a treatment liquid, the immersion treatment system comprising:
a treatment tank;
a fluidized unloader system comprising a product entry point, a product exit point, and a flow regulation device that establishes a discharge flow rate from the product exit point; and
a product separation device at the product exit point of the fluidized unloader system; and
a controller that operates the flow regulation device to the discharge flow rate.

20. The immersion treatment system of claim 19, wherein the discharge flow rate is controlled to achieve a desired residence time based at least in part on a volume of the fluidized unloader system.
